(19) United States
(12) Patent Application Publication
(10) Pub. No.: US 2017/0085506 A1
(43) Pub. Date: Mar. 23, 2017

(54) SYSTEM AND METHOD OF BIDIRECTIONAL TRANSCRIPTS FOR VOICE/TEXT MESSAGING

(71) Applicant: Beam Propulsion Lab Inc., Toronto (CA)

(72) Inventor: Alec Gordon, Toronto (CA)

(21) Appl. No.: 15/271,163

(22) Filed: Sep. 20, 2016

Related U.S. Application Data
(60) Provisional application No. 62/221,201, filed on Sep. 21, 2015.

(51) Int. Cl. H04L 12/58

(52) U.S. Cl. CPC H04L 51/046; H04L 51/32; H04L 51/38

(57) ABSTRACT

A method is provided for relaying instant messages between a first user of a first mobile device and a second user of a second mobile device. By input through an interface of an instant messaging application, a first instant message is received from a first user of a first mobile device, at least a portion of which first instant message is recorded as a voice input. The voice input is automatically transcribed as text as it is received. The first instant message is transmitted to an instant messaging application on a second mobile device. Voice and transcribed text portions of the first instant message are transmitted substantially simultaneously as the first instant message is received.

### CROSS-REFERENCE TO RELATED APPLICATION

This application claims the benefit of U.S. Provisional Application No. 62/221,201, filed Sep. 21, 2015. The priority application is hereby incorporated herein by reference in its entirety.

### FIELD OF THE INVENTION

The invention relates to instant messaging and more particularly relates to methods of relaying instant messages in voice and text form, wherein voice is also transcribed.

### BACKGROUND

Online chat and instant messaging differ from other technologies such as email as they are near real-time communication methods. This has allowed instant messaging to become a great social networking tool. IM allows people to stay in touch with friends and family by using Internet chat conversations to relay information back and forth in near real-time. Instant messaging allows near real-time communication between two people in any part of the world without having to pay the international or domestic long distance charges associated with using phones to make calls or send SMS messages.

IM messages are typed by a user. When a user is driving or walking, sending IM text messages may not be safe or convenient.

Voice Messaging allows a participant to instantly communicate with a contact or group using voice. The sender has to press and hold a button to record a message and then send it to the recipient. The Voice Messaging app installed at the recipient's device then automatically downloads the voice message. This is more convenient than a voice mail which requires a user to login i.e. provide a password to get access to the voice mail. But the recipient of a voice message may have an issue listening to the message in a noisy environment and may prefer a text message.

People with speech impediments have a communication disorder where normal speech is disrupted. Examples include stuttering, lisps and the like. People who are mute, or totally unable to speak, also have problems communicating over a telephone. Similarly, people with hearing impairment, a partial or total inability to hear (deaf and hard of hearing often abbreviated DHH), are usually unable to use the traditional phone system.

There are many different dedicated systems which assist individuals with speech impediments and hearing impairments to communicate. For example, many hearing impaired individuals use assistive devices or systems for communicating by telephone. Such devices or systems include telephone typewriters (TTY) which are also known as textphone, minicom and telecommunications device for the deaf (TDD). These devices look like typewriters or word processors and transmit typed text over regular telephone lines. This allows communication through visual messaging. TTYs can transmit messages to individuals who don't have TTY by using the National Relay service which is an operator that acts as a messenger to each caller.

There are several new telecommunications relay service technologies including IP Relay and captioned telephone technologies. A deaf or hard of hearing (DHH) person can communicate over the phone with a hearing person via a human translator.

Since these are dedicated systems, interoperability with other systems is limited. Thus individuals with speaking and hearing impairments face inconvenience, delays and problems when communicating with individuals from the general public. For unimpaired users, it would also be beneficial to have a system allowing for transitioning between voice and text input while benefiting from the convenience and cost-efficiency of an instant messaging system, and allowing for a full transcript of all portions of the conversation, including those input by voice. Among other advantages, the present system allows simplified and streamlined voice and/or text communications with a continuous transcript.

### SUMMARY

Broadly speaking, the present invention provides a system and method that allows participants a convenient and efficient way to participate in an IM session either with text or voice and switch between the two input modalities as needed.

The system and method provide a mechanism for more than one participant in an IM session to send and receive transcripts for the voice conversation that may be carried out between the participants. The transcripts may be received in real-time between the IM clients engaged in a chat session. This allows for one texts, one talks, or when both get on the call, there is transcription (preferably in real-time) within the chat/IM user interface.

People with speech impediments have a communication disorder where normal speech is disrupted in cases of stuttering, lisps and the like while those who are totally unable to speak (mute) have problems communicating over a phone.

In one embodiment a first user logs into the IM client. The users may need to sign up with an IM service provider implementing the system and method. Signing up to an online service/system is well known in the art and may require a user to provide their credentials e.g. a user name and a password. The IM service provider then creates a unique user ID for the user. A unique user ID is provided to each user so that each user can be identified uniquely in the system so that the messages and other notification may be correctly routed to their devices as per their preferences.

There may be default settings and a user may opt to either accept these default settings or may opt to modify these setting for personalization to suit their needs e.g. a user may define their presence and availability preferences.

In one embodiment the first user goes to Buddy List, selects a second user and initiates an IM session. The first user may then start to send a voice message to the second user by e.g. pressing and holding a button on the touch screen of the mobile device. The user does not need to record the entire message before sending it. The voice message is sent in real-time as it is being spoken. Alternatively, this input may be seamless, akin to initiating a phone call.

The second user may then start to receive the speech and see the transcription text change in real-time as the first user communicates. Thus as the first user utters the words, these words are sent as a voice stream along with the textual transcription of these words to the second user.

Transcription refers to converting spoken words into written text. Most transcription is done on computers using technologies like Speech to Text (STT).

The second user receives the voice message from the first user along with the transcript of the speech in real-time. The second user may then start to respond with a voice message to the first user but may also have the option to respond using text.

The first user starts to receive the speech and sees the transcription text change in real-time if the second user sent a message using voice. But if the second user chooses to send the message using text, the first user sees the text sent by the second user as well as the text converted to a voice stream. Thus the first user is able to both read and listen to the message at the same time.

The first user receives the voice message from the second user along with transcript of the speech on the screen of the device being used for the IM session.

The text IM message may be composed of text, emoticons, data files, pictures and videos. Users may use the touch screen of the mobile device to compose the text, and add emoticons or may use the keyboard on the mobile device to do the same. In some embodiments, it may be possible to convert speech commands to emoticons in the transcript, or to add files (e.g. photo or video files).

Thus we note that the system and method allows the two users to communicate by voice or text through an IM interface without having the need to explicitly press/select the “send” button and the dialogue transcript is provided automatically. Also users have the option to switch between the two input modalities even mid-conversation.

In one embodiment the IM messages including the transcribed text and the voice clips being shared in the IM or Chat session may be encrypted using protocols like SSL/TLS.

In one embodiment the IM client embeds the logic for managing the synchronization of the state of content in the IM clients engaged in the IM/Chat session.

In another embodiment the server embeds the logic for managing the synchronization of the state of content in the IM clients engaged in the IM/Chat session.

In yet another embodiment the logic for managing the synchronization of the state of content in the IM clients engaged in the IM/Chat session is partially embedded in the IM client and partially embedded in the server.

A user may have the option to choose the method with which to send or receive communications (e.g. speech or text).

The Speech to Text engine may output text from the speech as words or syllables or alphabets and the system and method may then choose to display the transcribed text to the user in the same way.

The system and method may provide a mechanism to visually differentiate between the typed text and the transcribed text. For example, the typed text may have a different font and color than the transcribed text so that it can be visually identified and recognized. Alternatively, the typed text and transcribed text may appear as one continuous conversation, demarcated only by speaker/chat participant.

The voice and text messages may be time-stamped and displayed in a chronological order. In some embodiments the process of synchronization may use the time-stamped messages to put them in a given chronological order and to identify at what point in the audio file each word was spoken.

A participant sending a voice message to another participant may be able to correct the transcript of the voice in real-time or near real-time. In one embodiment a participant sending a voice message to another participant may be provided with a short list of words (suggestions) to make the edits/corrections. For example, the short list of words may be derived from the context of the previous exchange of messages as well as user preferences. The list of words suggested may also be derived from other sources e.g. a dictionary, a spell checker etc.

When the first user is speaking and transcribed text is displayed in the first cell and if the second user starts speaking at the same time (the transcribed text of the second user being displayed in the second cell) the algorithm would detect that both parties are speaking at the same time and continue the first user's sentence (starting the following word) in the third cell. This effect would continue to occur as long as the sentence is not finished (a sentence is finished when a default pause is recognized from the first user, or a UI input is picked up, such as pressing the Send/Finish button).

During the call, where the first user and the second user are both engaged in just speech conversation and the speech of both users is being transcribed by the system, once a pause is received with an approximate syntactical end, that “bubble” is stopped and new one is started. Thus if a first user spoke for a minute, once the speech has been transcribed, all transcribed text may not appear in the same bubble; instead there may be more than one distinct bubbles showing this transcribed text, and the breaking is at the points when a sentence has a clear end.

The system also permits a user to leave a voicemail and a transcription of the voicemail message will be sent as a real time text message.

In the context of a group call, each user participant has a unique tag and each user's voice is transcribed individually (through the individual user's app). Each user's respective transcription is tagged to the specific user. This is in contrast to existing systems which attempt to transcribe a group call or conference call by transcribing one audio stream of the entire group, such that an individual participant's words may not be captured at all (if there is cross-talk), or may not be accurately credited to the specific participant.

According to a first aspect of the invention, a method is provided for relaying instant messages between a first user of a first mobile device and a second user of a second mobile device. By input through an interface of an instant messaging application, a first instant message is received from a first user of a first mobile device, at least a portion of which first instant message is recorded as a voice input. The voice input is automatically transcribed as text as it is received. The first instant message is transmitted to an instant messaging application on a second mobile device. Voice and transcribed text portions of the first instant message are transmitted substantially simultaneously as the first instant message is received.

The transcribed text and voice input may be transmitted word-by-word, syllable-by-syllable, or by another interval-based transmission, for example, after one of:
a predetermined number of characters in the transcribed text;
a predetermined time interval; or
a predetermined time interval with no voice or text input.

The first instant message may further include a portion input by the first user as text. In this case, the input text and the transcribed text are displayed together on the second mobile device as a single continuous message.

Preferably, the second user can playback the voice portion while reading the transcribed text of the first instant message.

The system allows a second user to respond to the first user by the same method, namely:
by input through an interface of the instant messaging application on the second mobile device, receiving a second instant message from the second user of the second mobile device, through text input, voice input, or a combination;
automatically transcribing text of any voice input of the second instant message as it is received; and
transmitting the second instant message to the application on the first mobile device, wherein any voice portions are transmitted with their transcribed text portions substantially simultaneously as the second instant message is received.

Preferably, the second instant message is displayed on the first and second mobile devices in a bubble below the first instant message.

Preferably, the transcribed text (or input text) can be deleted or revised.

Preferably, the transcribed text (or input text) can be searched.

Each message (bubble) is preferably associated with its sender—so for example, the first instant message is preferably shown associated with the first user, and the second instant message is preferably shown associated with the second user.

The method is preferably repeatable, such that a back and forth conversation of first and second instant messages is formed, including transcribed text of all portions of all messages input by voice. The entire conversation is preferably searchable.

The transcribing step may include timestamping the voice recording as each word is converted to text. This marks where in the recording each word was spoken. So the audio file can be played back to start from a very precise point (i.e. where a particular word was spoken). The interface may allow the sending or receiving user to select words on the transcript to playback. Therefore, in this sense, the audio and text files are not separate entities but a usable combined format.

Preferably, input text is convertible to speech by a TTS (text-to-speech) function, and the speech is also transmitted to the second mobile device.

Preferably, the transcribing uses an STT (speech-to-text) function.

The STT function may be carried out at least in part on the first mobile device.

The messages are preferably exchanged through MQTT.

In one embodiment, the first instant message is a voicemail message.

In one embodiment, the conversation is a group call, and each user is provided with a unique tag or identifier, such that each user's voice input is transcribed distinctly from that of the other users on the group call.

Devices where invention can be advantageously used may include but not limited to a personal computer (PC), which may include but not limited to a home PC, corporate PC, a Server, a laptop, a Netbook, tablet computers, a Mac, touch-screen computers running any number of different operating systems e.g. MS Windows, Apple iOS, Google Android, Linux, Ubuntu, etc. a cellular phone, a Smartphone, wearable technologies e.g. SmartWatches like iWatch, augmented reality headgear, a PDA, a tablet, an iPhone, an iPad, an iPod, an iPad, a PVR, a settop box, wireless enabled Blu-ray player, a TV, a SmartTV, wireless enabled connected devices, e-book readers e.g. Kindle or Kindle DX, Nook, etc. gaming consoles, and other such devices that may be capable of text, voice and video communications. Other embodiments may also use devices like Samsung's Smart Window, Google Glasses, Corning's new glass technologies, and other innovations and technologies that may be applicable to the invention at present or in the future.

Without limiting the solution to individual users or enterprise users; the solution aims to provide a mechanism allowing a plurality of participants to have a conversation (some by voice, some by text) within an IM context.

### BRIEF DESCRIPTION OF THE FIGURES

FIG. 1 is a flow diagram of a method of exchanging instant messages according to a preferred embodiment of the present invention.

FIG. 2 is a conceptual diagram of a message being simultaneously input by voice and appearing as a transcript in an instant message bubble on interfaces of a first user and a second user.

FIG. 3 is a flow diagram of converting and transmitting (simultaneously) voice and transcribed text in an IM bubble.

FIG. 4 is a flow diagram of converting and transmitting (simultaneously) text and converted text-to-speech as a playable addon to an IM bubble.

FIG. 5 is a flow diagram of a timer process.

FIG. 6 is a flow diagram of a synchronization process.

### DETAILED DESCRIPTION

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements, as is common practice within the art. However, it will be appreciated that, in at least one embodiment, the components comprised in the method and tool are actually implemented in software.

As will be appreciated, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

In the preferred embodiment the program code may execute entirely on the server (or a cluster of servers), partly on a server and partly on a user's computer, as a stand-alone software package, partly on the user's computer and partly on a remote computer or entirely on the remote computer or server. In the latter scenario, the remote computer may be connected to the user's device e.g. a Smartphone through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the internet. The storage media can be inserted to the device where it is read. The device can then read program instructions stored on the storage media and present a user interface to the user. It should be noted that the terms computer, device, Smartphone etc. have been used interchangeably but imply any device that allows a user to install apps to send and receive instant messages.

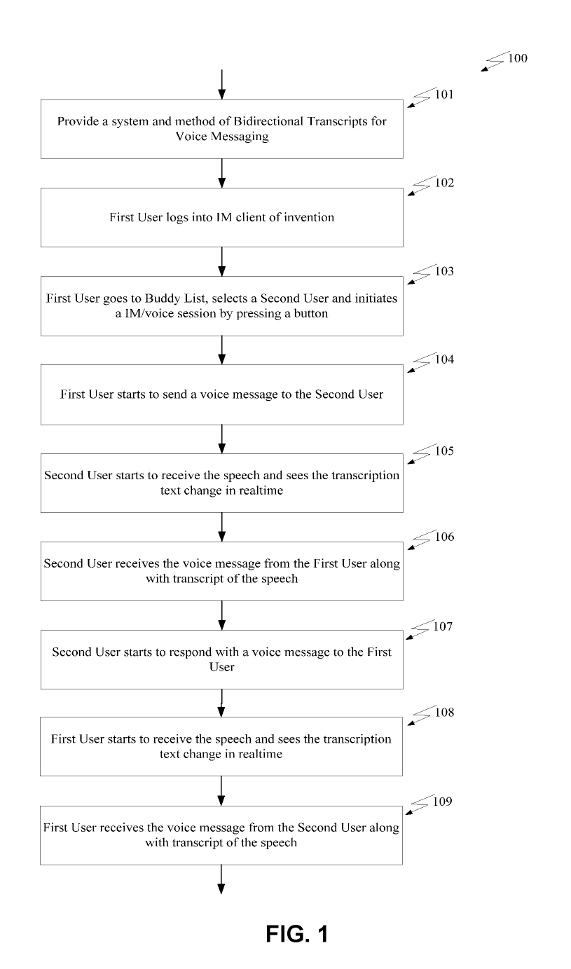

FIG. 1 shows the preferred embodiment of the method 100. A system and method is provided for bidirectional transcripts for voice messaging in an instant messaging application 101. More than one participant in an IM session can send and receive transcripts for the voice conversation that may be carried out between the participants. The transcripts may be received in real-time between the IM clients engaged in a chat session.

Online chat and instant messaging differ from other technologies such as email as they are near real-time communications but the users still have to send messages and wait while the other party types the response and sends the message by explicitly pressing the send button.

Instant Messaging (IM) is a set of communication technologies used for text-based communication between two or more participants over the Internet or other types of networks. IM-chat happens in real-time. Instant messaging (IM) is a type of online chat which offers real-time text transmission over the Internet. Short messages are typically transmitted bi-directionally between two parties, when each user chooses to complete a thought and select “send”. Some IM applications can use push technology to provide real-time text, which transmits messages character by character, as they are composed. More advanced instant messaging can add file transfer, clickable hyperlinks, Voice over IP, or video chat. Instant messaging systems tend to facilitate connections between specified known users (often using a contact list also known as a “buddy list” or “friend list”). Depending on the IM protocol, the technical architecture can be peer-to-peer (direct point-to-point transmission) or client-server (a central server retransmits messages from the sender to the receiver). Each modern IM service generally provides its own client, either a separately installed piece of software, or a browser-based client. These usually only work with the IM client supplier company's service, although some IM clients allow limited functionality with other services.

IM as a service allows users to send typed messages, pictures, files, and live video with sound to a recipient based on their screen name. This exchange can go back and forth as long as both parties desire. IM provides a personal way of communicating with friends and other known contacts. In order to use this service a user must download a program and install it on their computer. There are several available with some of the more popular ones being Yahoo Messenger, Windows Live Messenger, and AIM (America Online IM).

As noted earlier, in Instant Messaging short messages are typically transmitted bi-directionally between two parties only when a user chooses to complete a thought and select/press the “send” button. The present system provides a mechanism for a conversation to proceed among users in an IM context with full transcription of any voice input portions.

Instant Messaging is a real-time messaging format. IM is a specialized form of ‘chat’ between people who know each other. Both IM users must be online at the same time for IM to fully work. IM is not as popular as email, but it is popular amongst teenagers and people in office places that allow instant messaging.

A chat is a real-time online conversation between many computer users. It is like instant messaging, but with more than two people while most of the people are strangers to each other.

All participants must be in front of their computer at the same time. The chat takes place in a “chat room”, a virtual online room also called a channel. Users type their messages, and their messages appear on the monitor as text entries that scroll many screens deep. At a given time, two or more people can be in a chat room. They can freely send, receive and reply to messages from many chat users simultaneously. Non-IM types of chat include multicast transmission, usually referred to as “chat rooms”, where participants might be anonymous or might be previously known to each other (for example collaborators on a project that is using chat to facilitate communication).

In a chat instead of one-to-one communication, users log on to a themed based virtual room and communicate with several people only known by their screen names. By sending typed messages to the room all connected users can read and respond like a big online get together. There are numerous chat topics to choose from such as: hobbies, television shows, boy bands, sports, politics, health issues, and relationships.

A chat room window basically combines people who know each other based on their profile and registered screen name. If a person decides they want to “go private” with someone in the room, they can click that person's name and ask to send an Instant Message. At that point, both users are simultaneously still in the room while engaging in a private IM session in a separate pop up window. Once a screen name is known future Instant Messages can be sent to that person by simply opening the IM service, typing in the name and then typing a message.

Phone calling is specialized and requires that a user have a phone number, be a subscriber or a pay as you go customer of an operator. Phone calling is either traditional over wire-line or wireless infrastructure or IP based using protocols like SIP and transmitted over the internet between two devices that may not be traditional phones e.g. a laptop or a tablet computer. Traditional phone requires that a person (caller) dial a phone number of the other party (callee) and the other party needs to pick up the phone before a conversation can initiate between the caller and the callee.

Voice mail is typically associated with a phone number. In case a caller tries to reach another person and the callee is busy or does not want to pick up the phone the caller has the option to leave a voice mail for the callee. The callee then at a later time can listen to the voice mail by connecting to the phone service provider's infrastructure and providing a password to login to the voice mail system. Although voice mail has been around for many decades in today's world where every second may matter, retrieving a voice mail which may require several tens of seconds seems archaic.

People with speech impediments have a communication disorder where normal speech is disrupted in cases of stuttering, lisps and the like while those who are totally unable to speak (mute) have problems communicating over a phone.

Similarly, people with hearing impairment which is a partial or total inability to hear (deaf and hard of hearing often abbreviated DHH) are usually unable to use the traditional phone system. Many hearing impaired individuals use assistive devices in their daily lives. Such devices or systems that can enable such individuals to communicate by telephone can include using telephone typewriters (TTY) which are also known as textphone, minicom and telecommunications device for the deaf (TDD). These devices look like typewriters or word processors and transmit typed text over regular telephone lines. This allows communication through visual messaging. TTYs can transmit messages to individuals who don't have TTY by using the National Relay service which is an operator that acts as a messenger to each caller.

There are several new telecommunications relay service technologies including IP Relay and captioned telephone technologies. A deaf or hard of hearing (DHH) person can communicate over the phone with a hearing person via a human translator. Wireless, Internet and mobile phone/SMS text messaging are providing an alternate to TDD. Among other uses, the present system advantageously provides a means for people with speech impediments and hearing impairment to communicate with ease.

The first user logs into the IM client 102. The users may need to sign up with an IM service provider implementing the system and method. Signing up to an online service/system is well known in the art and may require a user to provide their credentials e.g. a user name and a password. The IM service provider then creates a unique user ID for the user. A unique user ID is provided to each user so that each user can be identified uniquely in the system so that the messages and other notification may be correctly routed to their devices as per their preferences.

There may be default settings and a user may opt to either accept these default settings or may opt to modify these settings for personalization to suit their needs e.g. a user may define their presence and availability preferences.

The first user goes to his/her Buddy List, selects a second user and initiates a IM/voice session by pressing a button 103.

A Buddy List or messenger list is a small active window inside an IM program that lists screen name contacts of other users who are contacts with whom a user can have an IM conversation. A Buddy List allows for quick communication between two users, whereby one clicks the name of the second and typing a message. A Buddy List may also indicate the “presence” of another user i.e. if that user is signed on to the service by placing some type of icon next to the name.

Presence refers to the ability to detect the electronic presence of other users who are connected to the Internet, through a PC or mobile device, and whether they are available in real-time. Presence information has wide applications in many communication services and is commonly used in applications like instant messaging clients, and discussion forums, VoIP clients etc. Presence is a status indicator that conveys ability and willingness of a potential communication partner. A user's client provides presence information (presence state) via a network connection to a presence service, which is stored in what constitutes his personal availability record and can be made available for distribution to other users to convey the availability for communication.

The first user starts to send a voice message to the second user 104. In one embodiment first user starts to send a voice message to the second user by e.g. pressing and holding a button on the touch screen of the mobile device. Unlike the prior art the user does not need to record the entire message before sending it. The voice message is sent in real-time as it is being spoken.

The second user starts to receive the speech and sees the transcription text change in real-time 105. In one embodiment second user starts to receive the speech and sees the transcription text change in real-time as the first user communicates. Thus as the first user utters the words, these words are sent as a voice stream along with the textual transcription of these words.

Transcription refers to converting spoken words into written text. Transcription can be human assisted where the transcriptionists are highly skilled people who provide verbatim transcripts in real-time. Transcription was originally a process carried out manually, i.e. with pencil and paper, using an analogue sound recording stored on, e.g., a tape cassette. Nowadays, most transcription is done on computers using technologies like Speech to Text (STT).

The second user receives the voice message from the first user along with transcript of the speech 106 preferably in real-time.

The second user starts to respond with a voice message to the first user 107. The second user may also have the option to respond using text.

The first user starts to receive the speech and sees the transcription text change in real-time 108. In one embodiment first user starts to receive the speech and sees the transcription text change in real-time if the second user sent a message using voice. But if the second user chooses to send the message using text, the first user sees the text sent by the second user as well as the text converted to a voice stream. Thus the first user is able to both read and listen to the message at the same time.

The first user receives the voice message from the second user along with transcript of the speech 109. In one embodiment the first user receives the voice message from the second user along with transcript of the speech on the screen of the device being used for the IM session.

An IM message may be composed of text, emoticons, data files, pictures and videos. Users may use the touch screen of the mobile device to compose the text, and add emoticons or may use the keyboard on the mobile device to do the same.

Thus we note that the system and method allows the two users to send and receive voice messages without having the need to explicitly press/select the “send” button and the dialogue transcript is provided automatically. Also users have the option to switch between the two input modalities i.e. send a message using voice when e.g. hands are busy and send a message using text when in a noisy environment where sending a voice message may be difficult. Similarly, the receiving party also has the option to switch between the two receiving modalities i.e. receive a message delivered as voice when say driving and receive a message delivered as text when hearing is impaired.

A user may have the option to choose the method with which to send a message for e.g. choose to send messages using speech, as well as being able to choose the method with which to receive the messages from other users e.g. choose to receive the messages as voice. Similarly, another user may choose to send messages using text while choosing to receive messages as voice.

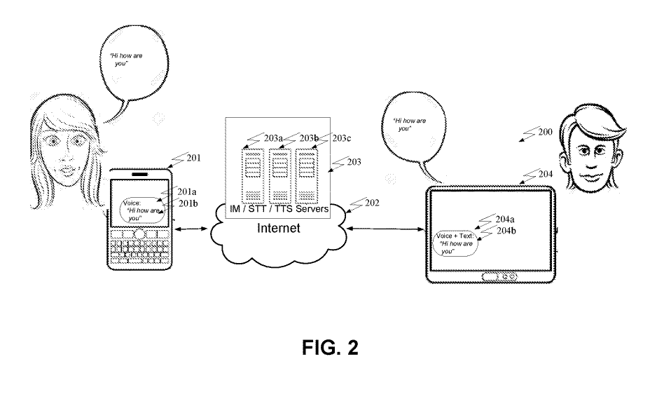

FIG. 2 shows one embodiment 200 where two users are logged into the instant messaging service and are exchanging instant messages.

The first user is using a mobile device 201 e.g. a Smartphone, the IM service is being accessed over the Internet 202 where IM/STT/TTS servers 203 are accessible; and the second user is using another mobile device 204 e.g. a tablet to engage in the IM conversation that is being facilitated by the IM servers 203a, STT servers 203b TTS servers 203c.

IM (Instant Messaging) Server(s) 203a facilitates the sending and receiving of instant messaging between two or more users.

STT (Speech to Text) Server(s) 203b convert the speech to text in real-time. Voice stream from a user is sent to the STT Server 203b which converts it to text. A Speech to Text (STT) system converts normal spoken language into text.

TTS (Text to Speech) Server(s) 203c convert the text to speech in real-time. Text stream from a user is sent to the TTS Server 203c which converts it to speech and relays it to the other party in the IM session. A Text to Speech (TTS) system converts normal language text into speech.

A first user's device 201 has an instant messaging client (IM client) 201a installed on it while a second user's device 204 has an IM client 204a installed on it.

For the first user, the text messages (IM conversation) that is in progress is depicted by 201a while the text characters entered by the first user are depicted by 201b on IM client running on first user's device 201.

Similarly, for the second user, the text messages (IM conversation) that is in progress is depicted by 204a while the text characters entered by the first user are depicted by 204b on IM client running on second user's device 204.

FIG. 2 shows an IM session that is in progress and two participants, a first user and a second user are exchanging content in the same IM bubble without having to press/select the send button. Any content (text, words, sentences, emoticons, characters, graphics etc.) that are added/deleted/modified by either of the participants is instantly updated in the same IM bubble without either party having to press/select the send button. One exemplary method for exchanging IM messages in real-time is described in applicant's U.S. patent application Ser. No. 15/073,504, filed Mar. 17, 2016, the contents of which are incorporated herein by reference.

A Text to Speech system (or “engine”) is composed of two parts: a front-end and a back-end. The front-end has two major tasks; first, it converts raw text containing symbols like numbers and abbreviations into the equivalent of written-out words. This process is called text normalization, pre-processing, or tokenization. The front-end then assigns phonetic transcriptions to each word, and divides and marks the text into prosodic units, like phrases, clauses, and sentences. The process of assigning phonetic transcriptions to words is called text-to-phoneme or grapheme-to-phoneme conversion. Phonetic transcriptions and prosody information together make up the symbolic linguistic representation that is output by the front-end. The back-end also referred to as the synthesizer, then converts the symbolic linguistic representation into sound. In certain systems, this part includes the computation of the target prosody (pitch contour, phoneme durations), which is then imposed on the output speech.

In one embodiment the Text to Speech/Speech to Text functionality is performed at a remote server that is accessible over a network for example the internet.

In another embodiment the Text to Speech/Speech to Text functionality is performed on client side e.g. the app may use the functionality embedded in a mobile device like a Smartphone to perform the Speech-to-Text and Text-to-Speech conversions.

In yet another embodiment the Text to Speech/Speech to Text functionality is performed partly on the on client side e.g. the app may use the functionality embedded in a mobile device like a Smartphone to perform the Speech-to-Text and Text-to-Speech conversions; and partly on the remote accessible server. In one scenario the first Speech-to-Text and Text-to-Speech conversions may be carried out on the mobile device while a second more through conversion may be performed at the server.

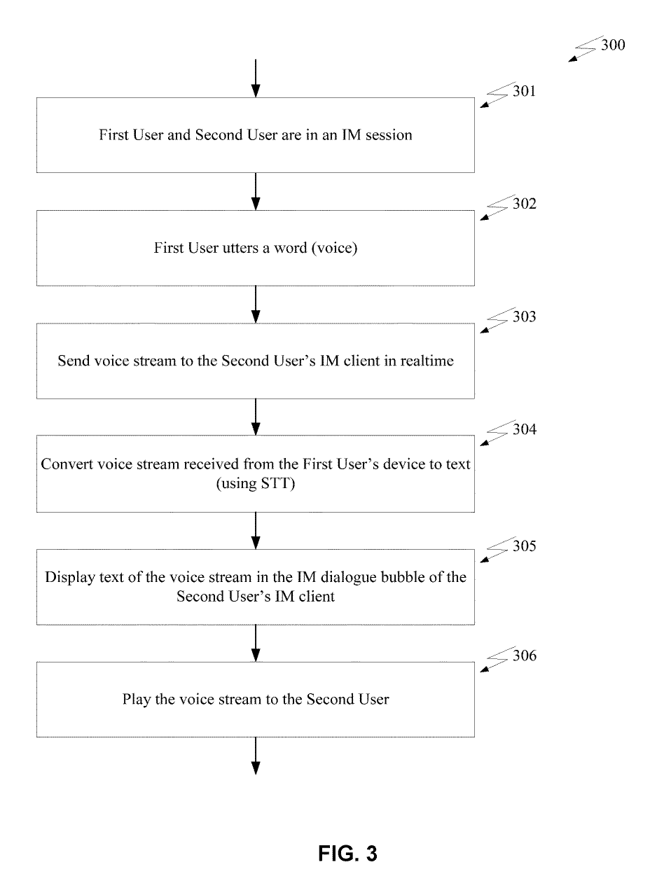

FIG. 3 shows one embodiment 300 where a first user and a second user are in an IM session 301. In one embodiment a first user and a second user are in an IM session that is being facilitated by servers that are accessible over the internet. FIG. 2 shows some such exemplary servers 203 that may include IM Servers 203a, STT (Speech to Text) Servers 203b, TTS (Text to Speech) Servers 203c and the like. In some embodiments these servers may be distinct hardware/computers while in other embodiments these servers may be virtual and may reside on the same physical hardware/computer.

The first user utters a word (voice) 302. In one embodiment the first user utters a word using voice as input. The first user may use the touchscreen of the mobile device to initiate the sending of the voice message e.g. touch a microphone button on the touchscreen of a Smartphone. There may be other means of initiating the voice stream for example a button on the keyboard of the Smartphone or tablet.

The voice stream is sent to the second user's IM client in real-time 303. The IM client on first user's device sends the voice stream to the IM client on the second user's device in real-time over a network e.g. the Internet, cellular data network or LAN.

It is to be understood that words and sentences are composed of character or letters. Thus in other embodiments the IM client of the first user sends characters on a word by word or sentence by sentence sequence to the IM client of the second user in real-time over the network. In such an embodiment the IM client waits for a word to be completed (entering a space indicates completion of a word) before sending it in real-time to the IM client of the other user; while the completion of a sentence may be signified by entering a period, a question mark, an exclamation mark or other such character that signifies the end of a sentence. In some embodiments this feature may be configurable either by the user or by the system.

The voice stream received from the first user's device is converted to text (using STT) 304.

In some embodiments the Speech to Text (STT) transcription may be performed at the server side.

While in some other embodiments the Speech to Text (STT) transcription may be performed at the client side such that the functionality may be embedded in the app that may be installed on a mobile device.

While in yet some other embodiments the Speech to Text (STT) transcription may be performed in a hybrid mechanism with assistance from both the client and the server, such that part of the functionality may be embedded in the app that may be installed on a mobile device and part of the Speech to Text conversion may be taking place on the remote server.

The text of the voice stream is displayed in the IM dialogue bubble of the second user's IM client 305.

The Speech to Text engine may output text from the speech as words or syllables or alphabets and the system and method may then choose to display the transcribed text to the user in the same way. Thus if the Speech to Text engine outputs text from the speech as syllables then display the syllables in real-time to the receiving user.

The system and method may provide a mechanism to visually differentiate between the typed text and the transcribed text. For example, the typed text may have a different font and color than the transcribed text so that it can be visually identified and recognized.

The voice stream can be played by the second user 306, e.g. through a speaker embedded in the mobile device.

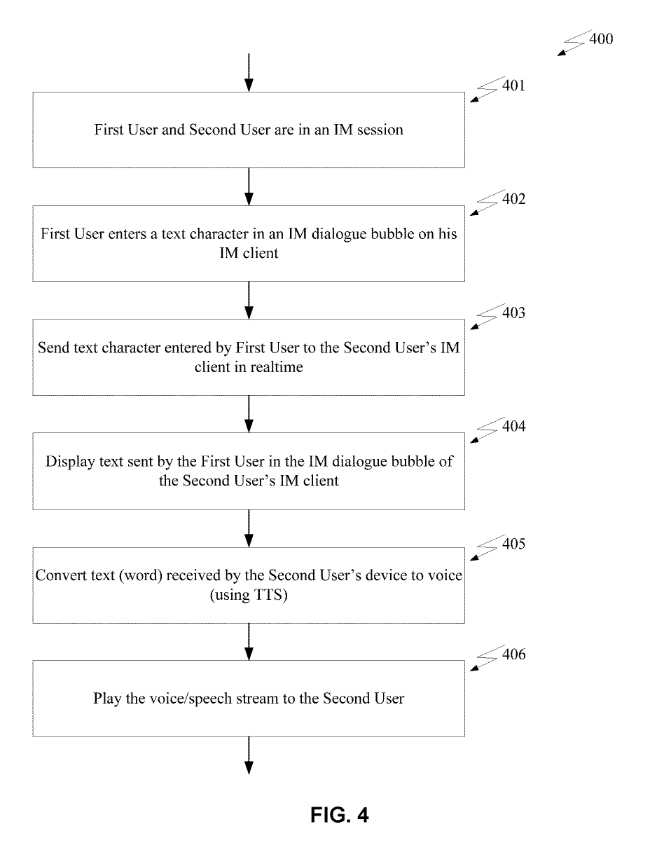

FIG. 4 shows one embodiment 400. The first user and the second user are in an IM session 401. In one embodiment first user and second user are in an IM session e.g. the first user is using a mobile device like an iPhone while the second user is using a tablet e.g. a Samsung Galaxy Tab S.

The first user enters a text character in an IM dialogue bubble on his IM client 402. In one embodiment the first user enters a text character in an IM dialogue bubble on his IM client using the touchscreen of the iPhone.

The text character entered by first user is sent to the second user's IM client in real-time 403.

The text sent by the first user is displayed in the IM dialogue bubble of the second user's IM client 404.

Text (words) received by the second user's device may be converted to voice (using TTS) 405. In some embodiments the Text to Speech (TTS) conversion may be performed at the client side such that the functionality may be embedded in the app that may be installed on a mobile device.

While in some other embodiments the Text to Speech (TTS) conversion may be performed at the client side.

While in yet some other embodiments the Text to Speech (TTS) conversion may be performed in a hybrid mechanism with assistance from both the client and the server, such that part of the functionality may be embedded in the app that may be installed on a mobile device and part of the Text to Speech conversion may be taking place on the remote server.

The voice/speech stream may be played by the second user 406, e.g. using the speaker embedded in the tablet.

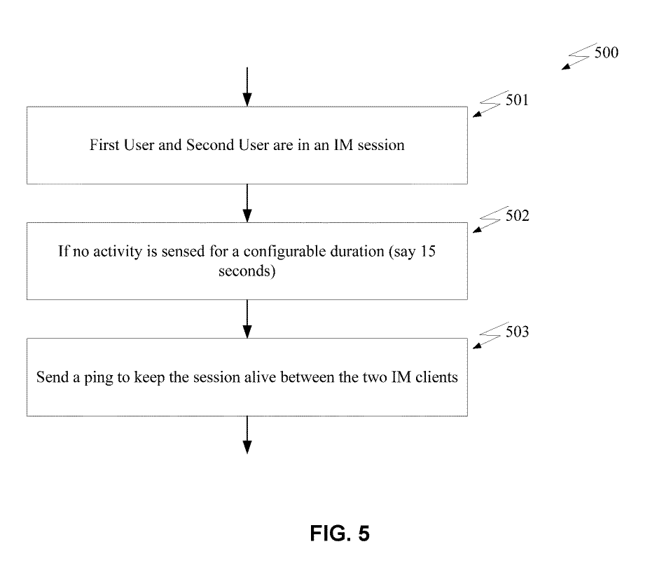

FIG. 5 shows one embodiment 500. A first user and a second user are in an IM session 501. In one embodiment two users, a first user and a second user are engaged in an IM conversation using mobile devices; e.g. a first user is using a Smartphone while a second user is using a tablet.

The system checks if no activity is detected for a configurable duration (say 15 seconds) 502. In one embodiment there may be a timer that is configurable and when it senses that there is no activity it starts the counter. Thus after receiving any command or input/deletion of a text character the timer starts and as soon as another command or text input is sensed the timer is reset and starts the counter again. Only in a case when the counter reaches and exceeds the configurable upper limit of the counter does it go to the next step.

The system may send a ping to keep the session alive between the two IM clients 503. Thus when there is no activity sensed and the timer reaches the configurable duration, in this case 15 seconds, the IM client sends a ping to the other IM client to keep the session alive.

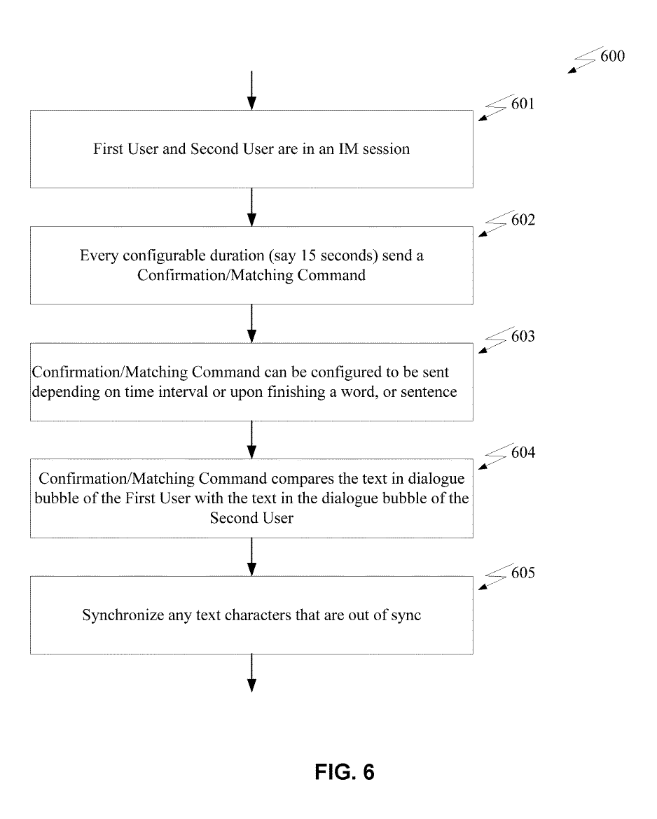

FIG. 6 shows one embodiment 600 which would apply to a situation where texting is the chosen information input method. first user and second user are in an IM session 601. In one embodiment a first user and a second user are in an IM session.

Every configurable duration (say 15 seconds) a Confirmation/Matching Command is sent 602. In one embodiment every configurable duration (say 15 seconds) send a Confirmation/Matching Command. The Confirmation/Matching Command may be sent over the network e.g. the internet, a cellular data network or the LAN.

The Confirmation/Matching Command can be configured to be sent depending on time interval or upon finishing a word, or sentence 603. In one embodiment the Confirmation/Matching Command may be configured to be sent from one IM client to another depending on time interval while in another embodiment the Confirmation/Matching Command is sent from an IM client upon the finishing a word, or a sentence being entered by a user.

The Confirmation/Matching Command compares the text in dialogue bubble of the first user with the text in the dialogue bubble of the second user 604. In one embodiment the Confirmation/Matching Command compares the text in the dialogue bubble of the first user with the text in the dialogue bubble of the second user.

Any text characters that are out of sync are synchronized 605. In one embodiment synchronize any text characters that are out of sync. Thus if the second user is entering text and upon the second user's finishing to enter a word send a Confirmation/Matching Command from the IM client of the second user to the IM client of the first user to compare the text in the respective IM bubbles and synchronize any text/content that is out of sync.

In one embodiment the voice and text messages may be time-stamped and displayed in a chronological order. In some embodiments the process of synchronization may use the time-stamped messages to put them in a given chronological order.

In one embodiment the IM client embeds the logic for managing the synchronization of the state of content in the IM clients engaged in the IM/Chat session.

In another embodiment the server embeds the logic for managing the synchronization of the state of content in the IM clients engaged in the IM/Chat session.

In yet another embodiment the logic for managing the synchronization of the state of content in the IM clients engaged in the IM/Chat session is partially embedded in the IM client and partially embedded in the server.

In one embodiment a participant sending a voice message to another participant may be able to correct the transcript of the voice in real-time or near real-time. In one embodiment a participant sending a voice message to another participant may be provided with a short list of words to make the edits/corrections. In one embodiment, for example the short list of words may be derived from the context of the previous exchange of messages as well as user preferences. While in other embodiments the list of words suggested may be derived from other sources e.g. a dictionary, a spell checker etc.

In some embodiments when voice is the chosen method of input, the system may advantageously provide a means for a user to correct/modify/edit/delete any text that is being transcribed by the Speech to Text engine. Thus a user originating a voice message may be provided with a list of options or list of words that prompts the speaker to manually configure the confirmation/matching command and send the corrected text to the other parties if he notice that the word displayed is incorrectly transcribed by the Speech to Text engine. This ensure that the correct transcription of the speech is sent to other participants and any system mistakes can easily be corrected manually by the sender as needed.

In one embodiment the IM participant initiating the entering or adding of any content may retain control over the content that is being shared in the IM or Chat session and may erase/delete/modify/edit the content at will. In another embodiment either participant in an IM session may erase/delete/modify/edit the content including the transcribed text and the voice clips being shared in the IM or Chat session.

In one embodiment the IM messages may be composed of text, emoticons, data files, voice clips, pictures and videos.

In one embodiment the IM messages including the transcribed text and the voice clips being shared in the IM or Chat session may be encrypted using protocols like SSL/TLS.

The preferred embodiment may use MQTT (formerly Message Queue Telemetry Transport) which is a machine-to-machine (M2M)/“Internet of Things” connectivity protocol. It was designed as an extremely lightweight publish/subscribe messaging transport and is useful for connections with remote locations where a small code footprint is required and/or network bandwidth is at a premium.

In one embodiment when the first user is speaking and transcribed text is displayed in the first cell and if the second user starts speaking at the same time (the transcribed text of the second user being displayed in the second cell) the algorithm would detect that both parties are speaking at the same time and continue first user's sentence (starting the following word) in the third cell. This effect would continue to occur as long as the sentence is not finished (a sentence is finished when a default pause is recognized from the first user, or a UI input is picked up, such as pressing the Send/Finish button).

In one embodiment during the call where the first user and the second user are both engaged in just speech conversation and speech of both users is being transcribed by the system, once a pause is received with an approximate syntactical end, that “bubble” is stopped and new one is started. Thus if a first user spoke for a minute, once the speech has been transcribed, all transcribed text may not appear in the same bubble; instead there may be more than one distinct bubbles showing this transcribed text, and the breaking is at the points when a sentence has a clear end.

Devices where invention can be advantageously used may include but not limited to a personal computer (PC), which may include but not limited to a home PC, corporate PC, a Server, a laptop, a Netbook, tablet computers, a Mac, touch-screen computers running any number of different operating systems e.g. MS Windows, Apple iOS, Google Android, Linux, Ubuntu, etc. a cellular phone, a Smartphone, wearable technologies e.g. SmartWatches like iWatch, augmented reality headgear, a PDA, a tablet, an iPhone, an iPad, an iPod, an iPad, a PVR, a settop box, wireless enabled Blu-ray player, a TV, a SmartTV, wireless enabled connected devices, e-book readers e.g. Kindle or Kindle DX, Nook, etc. gaming consoles, and other such devices that may be capable of text, voice and video communications. Other embodiments may also use devices like Samsung's Smart Window, Google Glasses, Corning's new glass technologies, and other innovations and technologies that may be applicable to the invention at present or in the future.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

It should be understood that although the term application has been used as an example in this disclosure the term may also apply to any other piece of software code where the embodiments are incorporated. The software application can be implemented in a standalone configuration or in combination with other software programs and is not limited to any particular operating system or programming paradigm described here.

Several exemplary embodiments/implementations have been included in this disclosure. The application is not limited to the cited examples.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of relaying instant messages of a first user of a first mobile device and a second user of a second mobile device, comprising:
by input through an interface of an instant messaging application, receiving a first instant message from a first user of a first mobile device, at least a portion of which first instant message is recorded as a voice input;
automatically transcribing text of the voice input as it is received; and
transmitting the first instant message to an instant messaging application on a second mobile device, wherein voice and transcribed text portions of the first instant message are transmitted substantially simultaneously as the first instant message is received.

2. The method of claim 1, wherein the transcribed text and voice input are transmitted word-by-word.

3. The method of claim 1, wherein the transcribed text and voice input are transmitted syllable-by-syllable.

4. The method of claim 1, wherein the transcribed text and voice input are transmitted after one of:
a predetermined number of characters in the transcribed text;
a predetermined time interval; or
a predetermined time interval with no voice or text input.

5. The method of claim 1, wherein the first instant message further includes a portion input by the first user as text.

6. The method of claim 5, wherein the input text and the transcribed text are displayed together on the second mobile device as a single continuous message.

7. The method of claim 1, wherein the second user can playback the voice portion while reading the transcribed text of the first instant message.

8. The method of claim 1, further comprising:
by input through an interface of the instant messaging application on the second mobile device, receiving a second instant message from the second user of the second mobile device, through text input, voice input, or a combination;
automatically transcribing text of any voice input of the second instant message as it is received; and
transmitting the second instant message to the application on the first mobile device, wherein any voice portions are transmitted with their transcribed text portions substantially simultaneously as the second instant message is received.

9. The method of claim 8, wherein the second instant message is displayed on the first and second mobile devices in a bubble below the first instant message.

10. The method of claim 1, wherein the transcribed text can be deleted or revised.

11. The method of claim 5, wherein the input text can be deleted or revised.

12. The method of claim 1, wherein the transcribed text can be searched.

13. The method of claim 5, wherein the transcribed text and any input text can be searched.

14. The method of claim 1, wherein the first instant message is shown associated with the first user.

15. The method of claim 8, wherein the second instant message is shown associated with the second user.

16. The method of claim 8, wherein the method is repeatable, such that a back and forth conversation of first and second instant messages is formed, including transcribed text of all portions of all messages input by voice.

17. The method of claim 16, wherein the entire conversation is searchable.

18. The method of claim 1, wherein the transcribing step includes timestamping the voice recording as each word is converted to text.

19. The method of claim 5, wherein input text is convertible to speech by a TTS function, and the speech is also transmitted to the second mobile device.

20. The method of claim 1, wherein the transcribing uses an STT function.

21. The method of claim 20, wherein the STT function is carried out at least in part on the first mobile device.

22. The method of claim 1, wherein the messages are exchanged through MQTT.

23. The method of claim 1, wherein the first instant message is a voicemail message.

24. The method of claim 16, wherein the conversation is a group call, and wherein each user has a unique tag or identifier, such that each user's voice input is transcribed distinctly from that of the other users on the group call.
